(19) United States
(12) Patent Application Publication
(10) Pub. No.: US 2008/0248363 A1
(43) Pub. Date: Oct. 9, 2008

(54) Composite electrolyte material having high ionic conductivity and depleted electronic conductivity and method for producing same

(75) Inventors: Vasantha R.W. AMARAKOON, Alfred, NY (US); Herbert GIESCHE, Alfred, NY (US); Rajalekshmi CHOCKALINGAM, Alfred, NY (US); Gary Eugene DEL REGNO, Honeoye Falls, NY (US)

Correspondence Address: BURR & BROWN, PO BOX 7068, SYRACUSE, NY, 13261-7068, US

(73) Assignee: Alfred University, Alfred, NY (US)

(21) Appl. No.: 11/827,744

(22) Filed: Jul. 13, 2007

Related U.S. Application Data
(60) Provisional application No. 60/910,532, filed on Apr. 6, 2007.
(60) Provisional application No. 60/927,701, filed on May 4, 2007.

(51) Int. Cl. H01M 8/10

(52) U.S. Cl. 429/33; 429/30

(57) ABSTRACT

A composite electrolyte material having increased ionic conductivity and suppressed electronic conductivity is provided. The composite electrolyte includes a first material exhibiting both ionic conductivity and electronic conductivity and a second material having electron trapping sites on the outer surface thereof. The first material is coated on the second material, or the second material is dispersed within the first material, and an electron depletion zone is created at interfaces between the first and second materials. The electrons trapped in the electron depletion zone do not contribute to the electronic conductivity of the composite electrolyte, and the ratio of ionic conductivity to electronic conductivity of the composite electrolyte is higher than that of the first material alone.

### CROSS REFERENCE TO RELATED APPLICATIONS

This application is related to U.S. Provisional Patent Application Ser. Nos. 60/910,532, filed on Apr. 6, 2007, and 60/927,701, filed on May 4, 2007, the entireties of which are incorporated herein.

### FIELD OF THE INVENTION

The present invention relates to composite electrolyte materials having high ionic conductivity and depleted electronic conductivity, and in particular, a composite electrolyte material including a continuous electrolyte matrix material exhibiting both ionic and electronic conductivity, and nano-sized inclusions, dispersed within the matrix material, that serve as electron trapping sites that trap electrons proximate the interface between the inclusions and the matrix material. The electronic conductivity is suppressed so that the ratio of ionic conductivity to electronic conductivity of the composite material is greater than that of the matrix material alone.

### BACKGROUND OF THE INVENTION

In solid oxide fuel cells (hereinafter referred to as SOFCs), a dense electrolyte membrane is sandwiched between two porous electrodes. The electrolyte membrane serves as a barrier to gas diffusion, but allows ion migration across the membrane. A typical SOFC consists of 8 mol % Y₂O₃ stabilized ZrO₂ as the electrolyte, a ceramic-metal composite of Ni+YSZ as the anode and La₁₋ₓSrₓMnO_{3-δ}, as the cathode (x between 0.15 and 0.25) and typically operates at temperatures close to 1000° C. It has been desired, however, to provide electrolyte membranes that could be implemented in SOFCs that can be operated at lower temperatures while exhibiting equivalent oxygen ion transport properties.

A major problem with electrolyte membranes that provide the desired amount of oxygen ion transfer at lower temperatures is that suitable materials typically exhibit both ionic and electronic conductivity, especially when exposed to a reducing atmosphere or low Partial Pressure of Oxygen (PO₂). The desired ionic conductivity of the electrolyte material is undesirably compromised by the electronic conductivity at lower temperature and low PO₂ operating conditions. For example, Gadolinium doped Ceria (hereinafter referred to as GDC) exhibits sufficient ionic conductivity at temperatures as low as 500 to 600° C., however, Cerium ions are reduced from the +IV oxidation state to a +III oxidation state under the reducing conditions present at one side of the membrane. Thus, the material also exhibits a significant degree of electronic conductivity that undesirably counteracts the desired oxygen diffusion capabilities of the membrane and reduced the overall effectiveness and efficiency of the membrane within the SOFC.

It would therefore be desirable to reduce the effects of the electronic conductivity of the electrolyte material without compromising the ionic conductivity in order to provide an electrolyte material for an SOFC membrane, for example, that is capable of being suitably used in an SOFC, but at lower operating temperatures than those of traditional SOFC operations. A material that enables the manufacture of SOFCs which can be operated at significantly lower temperatures would also serve to eliminate or at least reduce numerous other problems associated with conventionally known present SOFC designs that require higher operating temperatures.

In addition to the desire to reduce the influence of the electronic conductivity characteristics of the electrolyte material, so as to provide an electrolyte material suitable for use in a SOFC system at lower temperatures, it would also be desirable to improve the mechanical strength of the solid electrolyte material to improve performance characteristics and increase the useful life of the SOFC.

### SUMMARY OF THE INVENTION

It is an object of the present invention to provide a composite electrolyte material that overcomes the drawbacks of the prior art. In particular, it is an object of the present invention to suppress the electronic conductivity of an electrolyte material having both high ionic and also exhibiting electronic conductivity, especially under low PO₂ conditions, without compromising the ionic conductivity, to provide an electrolyte material that is capable of exhibiting high ionic conductivity when used in an SOFC at lower operating temperatures than those of traditional SOFC operations. It is also an object of the present invention to provide a composite electrolyte material having improved mechanical properties.

According to one embodiment of the present invention, a composite material is provided, comprising a first material exhibiting ionic conductivity and electronic conductivity, and a second material having electron acceptor states on at least portions of outer surfaces thereof and being dispersed within the first material so as to create an electron depletion zone at an interface between the first and the second materials. A ratio of ionic conductivity to electronic conductivity of the first material of the composite material is higher than that of the first material alone. According to one aspect of the present invention, the composite material comprises an electrolyte membrane for an SOFC.

The first material preferably comprises a mixed conductor that exhibits both ion and electron conductivity. More preferably, the first material comprises least one of one of cerium oxide, 8YSZ, 3YSZ, FeO₁₋ₓ and UO₂₋ₓ. In addition, the first material is preferably doped with a rare earth oxide material, particularly preferably Gadolinium.

It is also preferred that second material comprises at least one material selected from the group consisting of seed structures coated with the electron trapping material and seed structures doped with the electron trapping material.

According to a second embodiment of the present invention, a composite material is provided, comprising a first material comprising an electron trapping material, a second material exhibiting ionic conductivity and electronic conductivity coated on the first material, and an electron depletion zone at interfaces between the first material and the second material. The thickness of the coating layer of the second material is preferably in a range of 30 nm to 60 nm, and more preferably, the coating layer has a thickness of 50 nm.

The first material preferably comprises a seed material which can be in the form of particles, fibers and/or layers. Preferably, the seed material comprises nano-sized particles, and at least a portion of surfaces the nano-sized particles are coated with the electron trapping material. Preferably, the space between adjacent ones of the seed material is in a range of 50-100 nm.

It is also preferred that the electron depletion zone has a thickness in a range of 50 nm to 100 nm. For example, the seed particle could be coated with a thicker layer of the electron trapping substance to increase the distance between adjacent seed particles in the main ion conducting phase.

According to another aspect, the nano-sized particles are doped with the electron trapping material.

According to a third embodiment of the present invention, a composite electrolyte material is provided, comprising a composite electrolyte phase having high ionic conductivity and suppressed electronic conductivity and defining a continuous phase having an interconnected pore network. A strengthening material phase is provided within the interconnected pore network. A method of making the composite electrolyte material according to the third embodiment of the present invention is also provided. The method includes the steps of providing a structure comprising the composite electrolyte phase, bisque firing the structure to form the interconnected pore network in the composite electrolyte phase, infiltrating the strengthening material into the interconnected pore network, and sintering the structure after the infiltrating step to provide the composite electrolyte material. Preferably, the sintering step comprises microwave sintering.

The strengthening material preferably comprises an oxide stabilized zirconia that yields a finely sintered phase of tetragonal zirconia, whereby the mechanical structure and properties of the final composite material are improved. More preferably, the strengthening material comprises a material selected from the group consisting of yttria, calcia and magnesia.

According to the present invention, a solid electrolyte composite material is provided in which the low temperature and low PO₂ influences of the electronic conductivity characteristic of the electrolyte material is reduced through the incorporation of nano-sized ‘electron-trapping’ inclusions, thus enhancing the ionic contribution (i.e. increasing in the ionic transference number) of the continuous phase (matrix). The electron trapping feature is achieved by providing electron acceptor states located at interfaces between the electrolyte (ion conducting) matrix phase and the inclusion phase therein. The electrons associated with the continuous matrix phase are attracted to the receptor sites, which create electron depletion zone at the interface, and no longer contribute to the electronic conductivity of the ion conducting matrix material.

The ion conducting phase is not limited to the example of rare earth doped cerium oxide, and can equally be any other mixed conductor that has cations with varying oxidation states, such as Fe₁₋ₓO and UO₂₋ₓ.

The ‘nano-sized inclusions’ are preferably nano-sized particles, however, as mentioned above, other forms of ‘nano-inclusions’ are also suitably used. For example, the nano-sized inclusions can be incorporated in form of fibers, layers, or in any other nano-composite form, as long as a continuous phase of ionic conductivity exists and the electron-trapping inclusions are not spaced too far away from each other within the continuous phase.

It is, of course, important that the nano-sized material is provided in a sufficient amount and dispersed in a sufficient manner to provide the optimum amount of interfaces in order to be able to effectively suppress the electronic conductivity of the continuous ion conducting matrix/phase. Preferably, the inclusion phase giving the electron trapping interfaces is provided in the continuous ion conducting matrix phase so that the electron trapping interfaces are uniformly dispersed within the ion conducting matrix material. It should be noted, however, that uniform dispersion is not an absolute requirement, and it has been found that the electron trapping mechanism still functions sufficiently in cases where the electron trapping interfaces are not uniformly dispersed.

The nano-sized inclusions can be made of an insulating material or any material that does not readily form an electron conducting network and which has or can be made to have electron receptor sites on at least portions of the outer surfaces thereof. Examples of suitable materials that can be used to form the ionic conducting phase include, but are not limited to, insulating particles like alumina, or ion conducting inclusions such as seed particles of 8 mol % yttria-stabilized zirconia (8YSZ) or 3 mol % yttria-stabilized zirconia (3YSZ).

The nano-inclusions can be, for example, nano-sized alumina particles, which are insulating particles, that have been doped with a material, such as manganese cobalt oxide, either as a coating or incorporated within the particle structure, that provides electron acceptor states so that a electron trapping sites are provided at the interface between the conductive matrix material and the inclusions. The inclusions themselves can also be made of an electron trapping material, rather than having the electron trapping material provided as a dopant or coating layer on the inclusions. It is also important that the material of the inclusions should not dissolve within the matrix material. Suitable examples of inclusion materials include, but are not limited to any type of oxide material that does not react with the grain boundary/ion conducting phase such as MnO, CoO, Sb₂O₃, Cr₂O₃, ZrO₂ and aluminosilicates.

Preferably, the distance between the inclusion interfaces within the composite electrolyte material is approximately twice the width of the electron ‘depletion layer’ provided by the electron receptor/acceptor sites. The continuous ionic conductivity phase preferably has the greatest cross-sectional area, which thereby provides the highest ionic conductivity coupled with the lowest electronic conductivity. The distance is preferably in a range of 100 nm to 200 nm, depending on the thickness of the electron depletion zone/layer. The electron depletion layer/zone between the inclusion phase and the matrix phase is preferably 50-100 nm. If the thickness of the electron depletion layer exceed 100 nm, then the electron trapping function cannot be fully realized. If the thickness of the electron depletion layer is less than 50 nm, then the ionic conductor does not have sufficient thickness for optimum ionic conductivity

The electron trapping material that creates the electron depletion zone defining the electron trapping interfaces between the seed particles and the ion conducting phase can be made of any material that will create the desired electron depletion zone at the interface between the inclusions and the ionic conductivity phase. Preferably, the material is one which is capable of forming oxide/hydroxide sites/layers in order to attract the electrons from the continuous phase in the desired manner. Examples of suitable electron trapping materials include, but are not limited to oxides that are not soluble in the ion conducting phase.

According to one aspect of the present invention, nanometer-sized alumina particles (inclusions) are precipitated and doped with manganese cobalt oxide (electron trapping material) in chemical precipitation synthesis processes, and these ‘seed’ particles are coated with a 50 nm layer of gadolinium doped cerium oxide (the continuous ionic conducting phase). The nano-size of the alumina particles prevents the overall composition from being overloaded with non-conducting particles, and the coating process enhances a very uniform distribution of the alumina particles in the cerium oxide matrix. Afterwards the powders are calcined, shaped (either cast to form thin flexible tape-like structures using known tape forming methods or compacted, for example) and sintered.

In both conventional and microwave sintering, it is important for the sintering temperature to be sufficient to fully densify the ion conducting matrix phase and to provide zero porosity and an ion percolation path to ensure proper ionic conductivity. It is important that grain growth is suppressed during the sintering process in order to ensure the proper interface conditions to promote the desired ionic conductivity with suppressed electronic conductivity. Microwave sintering offers an advantage over conventional sintering in this respect.

Preferably, the composite green body or tape is sintered in a microwave sintering system for less than 5 hours at around 1250° C. with a heating rate and a cooling rate of 5-10° C. per minute in order to provide the most control over and suppression of grain growth.

### BRIEF DESCRIPTION OF THE DRAWINGS

FIG. 1A shows a schematic design of a composite structure according to one embodiment of the present invention. The energy band diagram for electron trapping across the interface is shown in the right image in FIG. 1B.

FIG. 2A is a schematic illustration of the oxygen ion percolation path provided using a GDC nano-coating on the surfaces of insulating grains according to the present invention.

FIG. 2B is a graph showing the results of electrical conductivity test performed on GDC and the nano-composite according to one embodiment of the present invention at varying oxygen partial pressures.

FIG. 3A is a graph showing time-temperature profiles used in comparative sintering testing.

FIGS. 3B and 3C are photomicrographs showing the difference in grain growth for samples sintered in a conventional sintering system and in a microwave sintering system.

FIGS. 4A and 4B show the bulk density and Vickers hardness of the various samples when both the conventional and microwave process were optimized to achieve the best possible densification.

FIG. 5 shows the results of XRD analysis of Gd_{0.2}Ce_{0.8}O_{1.9}-0.34MnO-0.34CoO—Al₂O₃ (Coat-C) coated powder calcined at different temperatures starting from room temperature through 900° C. (♡ represents Gd_{0.2}Ce_{0.8}O_{1.9} matches with X-ray PDF card 01-075-0162).

FIG. 6A shows the density of microwave sintered samples according to the examples.

FIG. 6B shows the density of conventionally sintered samples according to the examples.

FIG. 7A shows SEM micrographs of the Gd_{0.2}CeO_{0.8}-0.34MnO-0.34CoO—Al₂O₃ sintered sample.

FIG. 7B shows SEM micrographs of the Gd_{0.2}CeO_{0.8}-0.68MnO-0.68CoO—Al₂O₃ sintered sample.

FIG. 8 shows the impedance spectroscopy in air (‘ionic conductivity’) between 400° C. and 1000° C.

FIG. 9A shows the electrical conductivity as a function of oxygen partial pressure at 600° C.

FIG. 9B shows the electrical conductivity as a function of oxygen partial pressure 800° C.

### DETAILED DESCRIPTION OF THE INVENTION

According to one embodiment of the present invention, a GDC-coated nano-composite is created through chemical synthesis. The term nano-sized as used herein means a size on the order of about 100 nm or less. First an alumina sol is created. Then the manganese and cobalt oxide precursors are added to create the p-type phase at the alumina surface. Finally the composite is formed by coating with GDC. When the electrolyte is formed, the alumina is chemically created by mixing Al(OC₄H₉)₃ with water, stirring vigorously for 30 minutes, and adding HNO₃. After five days of aging at 95° C., an alumina sol, which will be the nano-composite's substrate, forms.

To form the first coating layer, a manganese compound [Mn(NO₃)₂.6H₂O+H₂O] and a cobalt compound [Co(NO₃)₂.6H₂O+H₂O] are added to the alumina sol. Finally NH₄OH+H₂O is stirred into the solution at 90° C. for 4 hours and aged for 24 hours, creating the manganese oxide and cobalt oxide coated alumina sol.

In the final steps, the resulting composite is coated with a 20% gadolinia-doped ceria. This is done by adding gadolinium nitrate [Gd(NO₃)₃.H₂O] and cerium nitrate [Ce(NO₃)₃.6H₂O] and stirring vigorously at 93° C. for six hours. Then NH₄OH+H₂O is added to the solution, and it is aged at room temperature for 24 hours. This will yield a second coating of GDC on the alumina particles. Finally, the sol is dried.

In the case of this specific embodiment, the manganese-cobalt oxide coated alumina nano-particle creates an electron trapping mechanism at the interface between alumina and ceria. The manganese and cobalt oxides in the composite structure has electron trapping acceptor states at the interfaces between the insulating grains (e.g., alumina) and semi-conducting (GDC) grain boundary regions. This enhances the ionic transference number of the GDC, which helps the GDC nano-composite overcome the electronic conductivity problems of conventional GDC, especially under low PO₂.

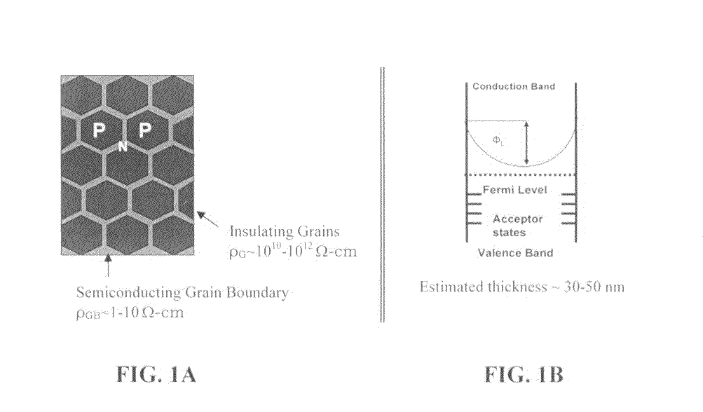

FIG. 1A shows a schematic design of such a composite structure. The energy band diagram for electron trapping across the interface is shown in FIG. 1B.

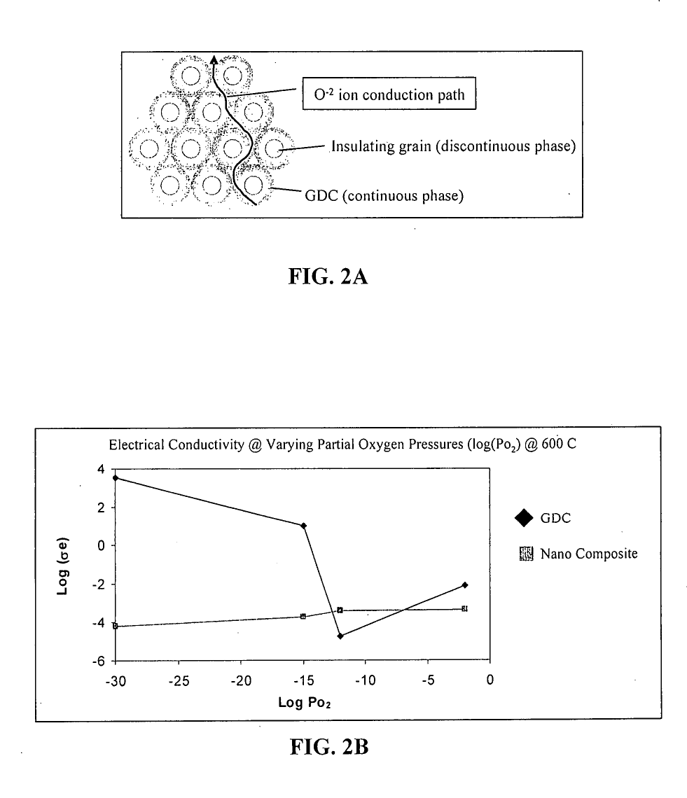

Electron trapping mechanisms at interface states are commonly observed for electro-ceramic devices such as varistors and thermistors, but have not heretofore been applied to electrolyte ion conductors for SOFCs. The estimated thickness of the CeO₂ grain boundary depletion regions is approximately, though not exactly 30-50 nm. This requires the use of nano-coatings of GDC on the surface of an insulating grain or seed particle (inclusion) and these layers have to densify during sintering in order to form a percolation path for oxygen ion conduction as shown in FIG. 2A.

FIG. 2B shows the results of testing the electrical conductivity of GDC and the nano-composite according to this embodiment of the present invention at 600° C. It can be seen that the nano-composite material did not have the dramatic increase in electronic conductivity of the conventional GDC at oxygen partial pressures at and below 10⁻¹⁵. This is not attributed to the elimination of the reducing atmosphere effect on GDC, but to the electron trapping mechanism at the interface between insulating grains and semiconducting grain boundaries of the nano-composite.

Also integral to creating the boundary-layer mechanism is the sintering process used to convert the nano-composite particles into a dense layer (electrolyte membrane). In conventional sintering, long cycle times (>24 hours) are required to densify the ceramic, but this long cycle time lead to grain growth. However, such grain growth can undesirably reduce the effectiveness of the electron trapping mechanism due to diffusion of GDC layers away from the interfacial region. Grain growth may also alter the ionic conductivity of the electrolyte, as some particles may fuse into a larger particle within the insulating non-continuous phase.

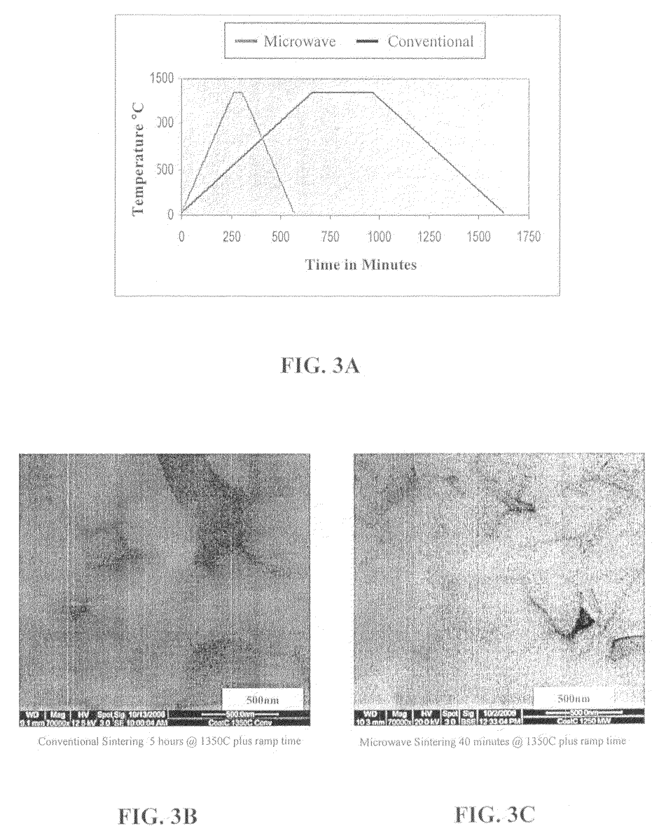

To better control the densification process, microwave sintering is preferably used. The microwave process has demonstrated a significant reduction in the cycle time necessary to densify the material. FIG. 3A shows the time-temperature profiles used to sinter the test specimens. FIGS. 3B and 3C show scanning electron microscope photomicrographs of the nano-composite sintered the conventional and microwave processes. The grain sizes seen in the conventionally sintered material are larger compared to the grains resulting from the microwave sintering process.

Over the last half century, electromagnetic processing of materials is a technology which has been developing into a viable and cost effective means of realizing changes, in materials, which would have otherwise only been possible by way of an externally generated thermal heating. Microwave frequency heating technology has expanded its breadth of applications from the food service industries to drying unfired ceramics, vulcanizing rubber, laminating plywood, and curing composites.

Electromagnetic materials processing technologies are inherently faster, environmentally cleaner and uniquely more uniform than conventional thermal processing technologies. Thermal technologies require combustible fossil fuels or electrical resistance heating elements. Fossil fuel based thermal heating technologies have large environmental impact footprints. Although electrical resistance heating is considerably cleaner, it is expensive and lacks energy efficiency, particularly in that it is still a thermal heating process. There are clear mechanistic distinctions that can be observed between electromagnetic and conventional heating technologies. For example, materials are heated from the outside inward from the infrared heat energy generated in conventional processes. On the other hand, in electromagnetic heating, the field interacts directly and internally with materials being processed, thereby generating heat from within the material outward. Furthermore, a high frequency molecular vibratory coupling occurs between the electromagnetic field and the materials being processed allowing a more direct relationship to be achieved between the electromagnetic energy and the matter being heated. This generates heat internally, volumetrically and uniformly within the materials being electromagnetically processed. As a consequence, this process is physically more energy efficient.

Refinements in both the equipment and methods used in electromagnetic processing of materials have made it possible to use this technology for firing advanced ceramics and powdered metals at very high temperatures. Additionally, the processing times have been dramatically reduced, as compared with conventional thermal processing, thereby minimizing the total energy expenditure required to process identical lots of material. The mechanical properties of materials processed by this method have also been shown to be superior to those fired by conventional means. Widespread use of this technology for more than the simple process of melting may now bring about the realization of materials with higher quality and lower energy costs from a per item perspective and delivered in less time.

Microwave sintering of materials over a range of temperatures from 400° C. to 2000° C. has been examined during the last quarter century. A variety of approaches have been used, to this end, to exploit those virtues offered through the use of microwave energy. There are several reasons why interest, in processing materials with microwave energy, is being renewed. For example, microwave materials processing offers the most significant prospect for reductions in manufacturing costs by virtue of reductions in energy usage and reduction of processing cycle times. Microwave materials processing has also shown an improvement in both product uniformity and yield quantity. In addition, microwave processing has yielded improvements in materials in the form of unique and controlled microstructure with finer grain size than is achievable by way of conventional sintering methods, retention of both nano-sized grains and nano-structures are possible, superior and near theoretical material properties has been demonstrated, synthesis of new materials has been made possible and decrystallization of materials has been shown to be possible, thereby eliminating the need to form glasses from completely molten material.

Microwave sintering may be classified into two distinct types. Direct microwave sintering can be achieved in specific materials as a consequence of the dielectric constant and the dielectric loss of the material at a specific microwave frequency. The specific frequency, that is the optimal frequency at which a given material will most effectively couple directly with microwave energy, is dictated by the complex permittivity of that material. That is to say, if the dielectric constant and the dielectric loss factor are such that when irradiated at a specific microwave frequency, the material will absorb, store, and transform into thermal energy the microwave energy to which it has been subjected. This behavioral phenomenon in materials is often referred to as susceptibility.

The susceptibility of a given material will become greater as the temperature of the material is increased. However, this phenomenal behavior diminishes in some materials as the dielectric loss of the materials increases to the point whereby the same material will become reflective to microwave energy.

Room temperature susceptibility is ideal for materials to be sintered by microwave energy. However, at 2.45 GHz, the most commonly used microwave frequency for materials processing, most materials are not readily susceptible at room temperature. Therefore, materials with high susceptibility at room temperature are required in concert with materials having low susceptibility at room temperature in order to achieve microwave sintering of low susceptibility materials. This method of microwave materials processing defines Hybrid sintering. The material with high susceptibility absorbs the microwave energy and transforms this energy into infrared energy, which is emitted, thereby heating the low susceptibility material. As the temperature of this secondary material increases, it becomes more susceptible to direct absorption of microwave radiation and subsequently couples directly with the microwave energy. In Hybrid heating, the primary susceptor material responds to microwave energy to become an infrared radiant heater. The secondary material responds to the radiant energy of the primary susceptor material until sufficient temperature has been achieved for the secondary materials to couple directly to the microwave radiation.

As mentioned above, the microwave process is innately more energy efficient, thermally uniform and proceeds much faster without significant grain growth, which is essential for the preservation of nano-structures, especially at the grain boundary region. In addition, the short sintering cycle time saves a significant amount of energy, which translates into a lower cost of the finished product.

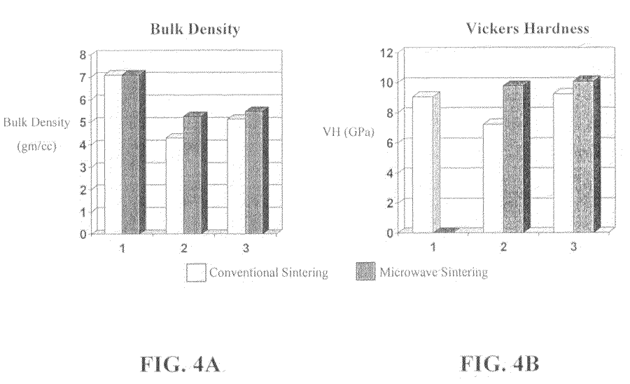

Another advantage of the microwave sintering process was seen in the form of increased densification of the nano-composites compared to the densities achieved using conventional sintering under comparable sintering conditions. FIGS. 4A and 4B show the bulk density and Vickers hardness of the various samples when both the conventional and microwave process were optimized to achieve the best possible densification. Sample 1 is 100% GDC and samples 2 and 3 are different nano-composite formulations.

Conventional GDC materials, for example, are generally lacking in strong physical properties, and consequently, conventional GDC cells are fragile. However, the increase in bulk density and Vickers Hardness, as well as the observed reduction in handling damage with the microwave sintered parts shows that the combination of nano-composites and microwave sintering improves the strength of the final electrolyte layer.

The examples below demonstrate that electronic conductivity of the electrolyte material can be suppressed by the presence of electron trapping interfaces distributed throughout the electrolyte material, for example, by manganese oxide and/or cobalt oxide doped/coated alumina seed particles or inclusions which create the electron trapping sites. As mentioned above, the electron trapping mechanism works over a certain distance (i.e., the electron depletion layer), which must be carefully controlled in order to provide and maximize the positive effects of suppressing the electronic conductivity.

The present invention is further described in detail herein below by way of examples, but is in no way limited to the specific examples herein.

### EXAMPLES

According to one embodiment of the present invention, Gadolinium is added to Ceria to create oxygen vacancies, which in effect enhances the oxygen conductivity of the material. However, as noted above, Cerium ions can also under go a reduction from the +IV to +III oxidation state, which leads to electronic conductivity, and which, in effect, reduces the usefulness of the material as an oxygen ion conductor membrane, since it can lead to recombination effects in the SOFC.

Reagent grade Al(OC₄H₉)₃, Mn(NO₃)₂2.H₂O, Co(NO₃)₂.6H₂O, Ce(NO₃)₂.6H₂O, Gd(NO₃)₂.6H₂O, and NH₄OH solution were obtained from Aldrich and used without further purification. All salts were pre-dissolved as 0.2 mol dm⁻³ stock-solutions.

Alumina sols were prepared by adding 123 g aluminum alkoxide under vigorous stirring into 900 g water at 75° C. After stirring for 30 minutes, 0.830 g conc. HNO₃ was added and the solution aged for an additional 5 days at 100° C. At that point 125 g of the alumina sol was used for the further coating process.

In about 100 to 200 ml of water 0.090 g of Mn(NO₃)₂₋₂H₂O, 0.091 g of Co(NO₃)₂.6H₂O, and approximately 1 g of a 28 wt % ammonia solution were slowly added at 90° C., stirred for 4 hours and further aged for an additional 12 hours. Finally, in about 600 to 700 ml of water 20.74 g of Ce(NO₃)₂.6H₂O, 5.388 g of Gd(NO₃)₂.6H₂O, and approximately 4.5 g of a 28 wt % ammonia solution were slowly added at 90° C., stirred for 4 hours and further aged for an additional 12 hours.

Water was slowly evaporated at 100° C. and the powder was pre-calcined at 900° C. for 4 hours in air. The above described process yielded in an overall (theoretical) composition of 49.84 wt % Al, 0.68% Mn, 0.68% Co, 39.05% Ce, and 9.76% Gd (sample COAT-B).

In addition, a composition with half the concentration for Mn and Co (sample COAT-C) was prepared as well as a ‘simple’ Gd-doped Ceria with a 20/80 ratio (sample GdC).

After calcination, the powders were ground and sieved using a 75 μm mesh. 2 to 3 g pellets were uniaxially die-pressed at 15 MPa pressure and then cold isostatically pressed at 200 MPa to form cylindrical green pellets having a height of 3 mm and a diameter of 11 mm. The pellets were sintered in one of (a) a ‘conventional’ furnace at 2° C./min heating rate to 1350° C. (5 hours hold) followed by 2° C./min cool-down, and (b) a hybrid microwave furnace at 10° C./min heating rate to 1350° C. (30 minutes hold) followed by 10° C./min cool-down.

### Characterization

X-ray diffraction experiments were performed using a Philips, XRG 3100 X-ray generator. The X-ray generator was set to 40 kV and 20 mA current, utilizing Cu—Kα radiation with a wavelength of 1.54 Å, from 20° to 70° (2θ), with a step size of 0.04° and count times of 4.0 seconds.

SEM analysis was performed using an FEG 200 (FEI Company, Hillsboro, Oreg.) environmental SEM (ESEM) with a field emission gun (FEG) operating at 10 kV. The energy-dispersive-X-ray spectrometer (EDS) attached to the ESEM was used for chemical composition analysis. Powder samples were prepared by drying suspensions and in the case of sintered pellets, fracture surfaces were observed. Before analyzing all samples were coated with a 60:40 Au:Pd conductive layer in order to prevent charge build-up.

Impedance spectroscopy was used in a frequency range of 1 Hz to 10 MHz using a Solartron 1260 impedance/gain analyzer along with a Centurion Qex furnace. Sintered cylindrical specimens were coated on both faces with platinum ink A3788A (Engelhard—Lot # M34831) and cured at 900° C. (30 minutes hold). Correction files were used to account for and eliminate any resistance due to the leads. All of the data was collected while sweeping from high to low frequency in order to avoid polarization in the sample. Nyquist plots were then generated at each temperature and analyzed in the Z-View software (Version 2.6 Scribner Associates, Inc, Southern Pines, N.C., 2002).

A Kepco power supply (55V-2 A max. set at 20V) was used in combination with a Keithley Multimeter to measure 4-Point DC conductivity. Sintered pellets were shaped into rectangular bars and electroded with platinum ink A3788A (Engelhard—Lot # M34831). Measurements were performed between 200° C. to 1000° C. (in air) and 500° C. to 1200° C. (controlled atmosphere). The oxygen pressure (10⁻³⁰ to 2 atm.) was controlled by using Ar—O₂ or CO—CO₂ mixtures. For each data point temperature and Po₂-equilibrium were established before making the final measurement (indicated by a steady value of conductivity).

### Sintering

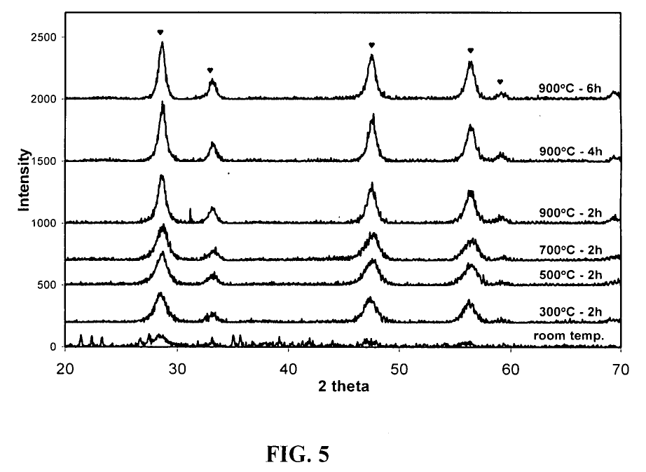

TGA/DTA experiments indicated an approximate weight-loss between 35 and 40 wt % at a temperature of about 250° C. and some minor continued weight-loss until about 500° C. The as prepared powders were essentially amorphous. However, even at temperatures of 300° C., the Gd_{0.2}Ce_{0.8}O_{1.9} phase was clearly noticed in XRD tests (see FIG. 5). The XRD-peaks indicated only a minor increase in crystallite size as the calcination temperature was increased to 900° C.

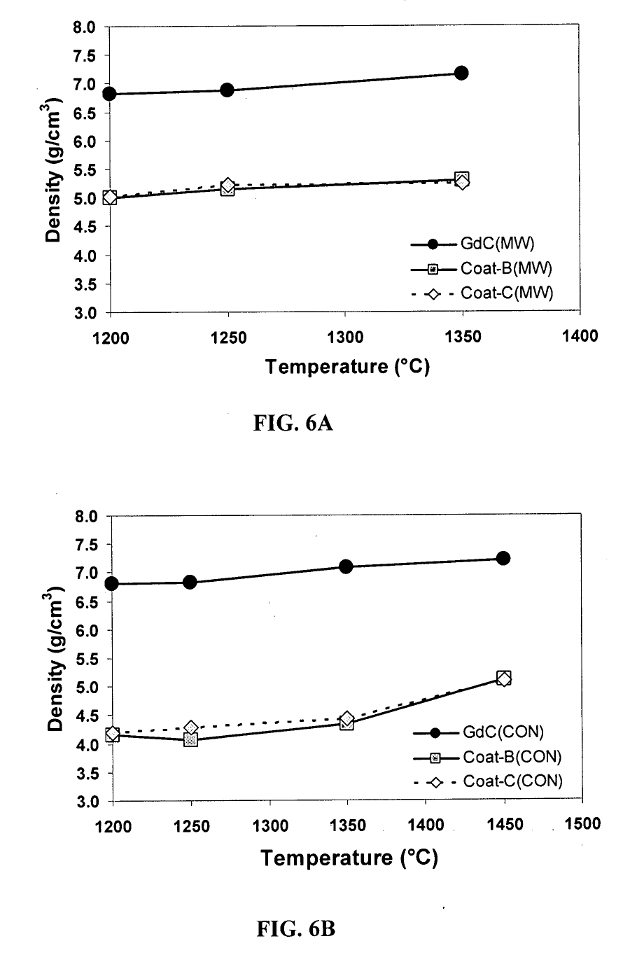

Density measurements, as shown in FIGS. 6A and 6B, demonstrated an advantage of microwave sintering, whereby the coated samples reached densities above 5.0 g/cm³ at 1250° C. in the microwave sintering experiment. On the other hand, a higher temperature of 1450° C. was needed in order to achieve comparable density measurements using conventional sintering.

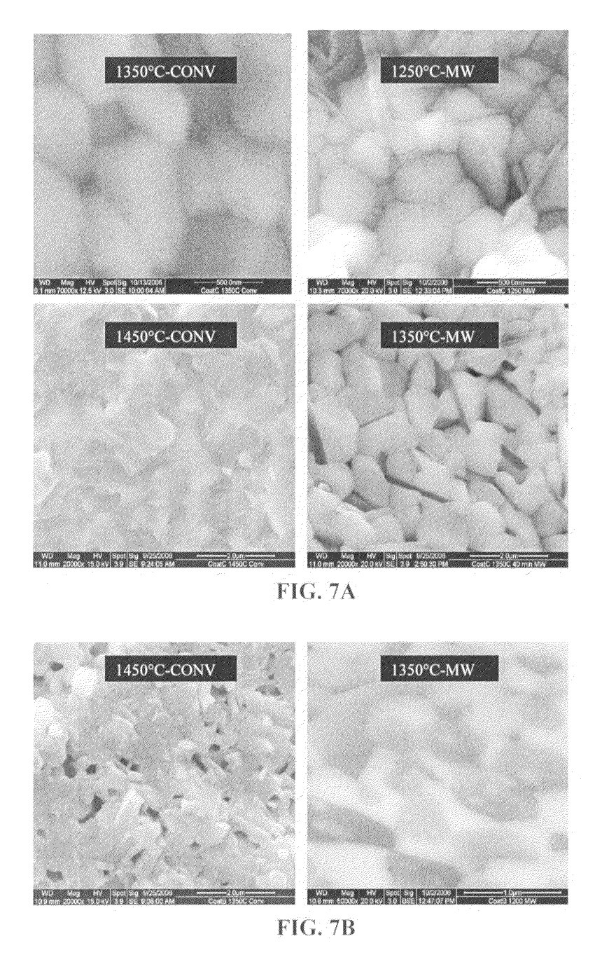

In addition, microwave sintering lead to higher hardness values as shown in Table 1. This effect can be explained by the smaller grain sizes, which are beneficially encountered in microwave sintering due to the relatively ‘lower’ sintering temperatures needed to reach a certain density, and the faster sintering cycle (30 minutes versus 5 hours hold time at temperature). FIGS. 7A and 7B shows micrographs of fracture surfaces for samples sintered at different temperatures. The average grain size is clearly below 1 μm and it is also evident that microwave sintering requires lower indicated temperatures in order to achieve comparable (or higher) densities than conventional firing. It should also be noted that GDC samples without the second phase showed micro-cracks.

TABLE 1

| | Vickers Hardness (GPa) | Vickers Hardness (GPa) |
|---|---|---|
| | Conventional Sintered | Microwave Sintered |
| Sample ID | 1450° C. | 1350° C. |
| GDC | 9.1 | |
| Coat-C | 7.2 | 9.8 |
| Coat-B | 9.2 | 10.1 |

### Conductivity

As mentioned above, while adding Gadolinium to Ceria creates oxygen vacancies, which in effect will enhance the oxygen conductivity, the cerium ions undergo a reduction from the +IV to +III oxidation state. This leads to electronic conductivity, which, in effect, reduces the usefulness of the composite material as an oxygen ion conductor membrane, since it can lead to undesirable recombination effects in the SOFC.

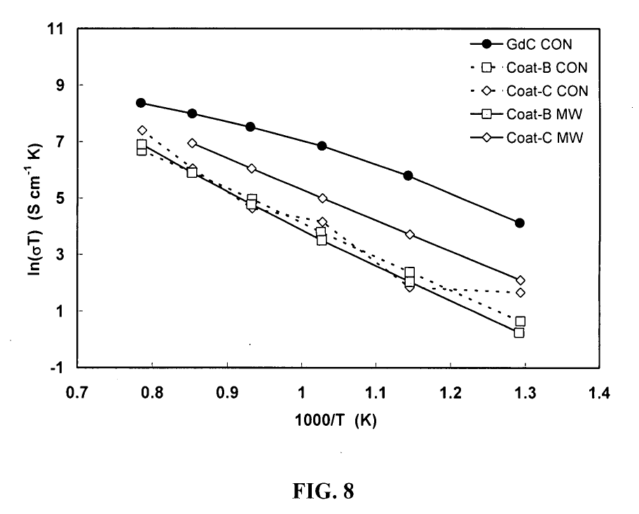

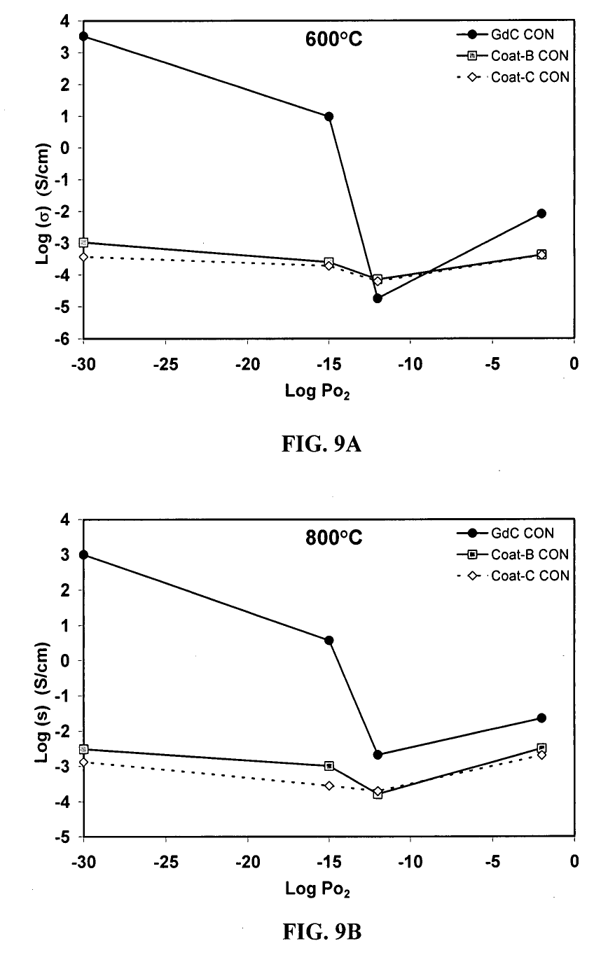

Measuring the conductivity in air (FIG. 8) is essentially due to ion conductivity only. It is not surprising that, compared with the ‘pure’ gadolinium doped ceria (GdC), the conductivity of the nano-composite samples are lower since 50 wt % of the material is ‘insulating’ alumina nano-seeds. However, when the conductivity was measured at lower oxygen partial pressures (where electronic conductivity becomes more significant as seen by the increased conductivity below oxygen pressures of 10⁻¹⁵ for the pure GdC), the nano-composite suppressed the electronic conductivity which remained low at around 10⁻³ to 10⁻⁴ S/cm, and no electronic conductivity due to the Ce^{+IV} to Ce^{+III} conversion was detected (see FIGS. 9A and 9B).

Further Improving Mechanical properties of the Composite Electrolyte

In addition to the desire to reduce the influence of the electronic conductivity characteristics of the composite electrolyte material under low temperature and low PO₂ conditions, it is also desirable to improve the mechanical strength of the solid electrolyte material to improve performance characteristics and increase the useful life of the SOFC. As explained above, using microwave sintering offers several advantages over conventional sintering in this regard. The present inventors found that the novel composite electrolyte material of the present invention can be further structurally fortified to meet desire for improved mechanical characteristics in the following manner.

Of course, it is also desirable for the electrolyte membrane or structure to have zero porosity for optimal ion conductivity, which is achieved during the sintering step. However, in order to give added strength to the composite, the composite material is formed into a green body structure such as a tape, pellet or other suitable structure depending on the purpose, and green body is bisque fired at temperatures in a range of 850-900° C. for 2-4 hours, before sintering, in order to intentionally create an interconnected pore network within the continuous composite electrolyte structure. The continuous and interconnected pore structure of the composite electrolyte is then infiltrated with a strengthening composition, such as but not limited to 3 YSZ, and then sintered at a temp of 1475-1525° C. for 1-2 hours to provide a final sintered composite electrolyte material having essentially zero porosity, improved mechanical properties, such as strength and flexibility, along with improved ionic conductivity characteristics.

The strengthening composition is not limited to 3YSZ, and examples of other suitable strengthening compositions include, but are not limited to 8YSZ (when used to strengthen an ion conducting phase of GDC when the seed particles are rare earth doped 3YSZ seed particles, for example). Again, microwave sintering is preferred from the standpoint of controlling grain growth in the composite electrolyte so as to retain the benefits of the suppressed electronic conductivity provided by the electron depletion zones in connection with the inclusions. Conventional sintering techniques can also be employed, however, the sintering time and temperatures must be carefully tailored and controlled in order to prevent excessive grain growth, and microwave sintering remains the preferred method.

What is claimed is:

1. A composite material comprising:
a first material exhibiting ionic conductivity and electronic conductivity; and
a second material having electron acceptor states on at least portions of outer surfaces thereof and being dispersed within said first material so as to create an electron depletion zone at an interface between said first and said second materials;
wherein a ratio of ionic conductivity to electronic conductivity of said first material of said composite material is higher than that of said first material alone.

2. The composite material of claim 1 comprising an electrolyte membrane for an SOFC.

3. The composite material of claim 1, wherein said first material comprises a mixed conductor that exhibits both ion and electron conductivity

4. The composite material of claim 3, wherein said first material comprises at least one of one of cerium oxide, 8YSZ, 3YSZ, FeO₁₋ₓ, and UO_{2-X}.

5. The composite material of claim 3, wherein said first material is doped with a rare earth oxide material.

6. The composite material of claim 5, wherein said first material is doped with gadolinium.

7. The composite material of claim 1, wherein said second material comprises at least one material selected from the group consisting of seed structures coated with the electron trapping material and seed structures doped with the electron trapping material.

8. A composite material comprising:
a first material comprising an electron trapping material;
a second material exhibiting ionic conductivity and electronic conductivity coated on said first material; and
an electron depletion zone at interfaces between said first material and said second material.

9. The composite of claim 8, wherein the first material comprises a seed material.

10. The composite of claim 9, wherein said seed material comprises one of particles, fibers and layers.

11. The composite of claim 9, wherein said seed material comprises nano-sized particles.

12. The composite of claim 11, wherein at least a portion of surfaces said nano-sized particles are coated with said electron trapping material.

13. The composite of claim 11, wherein said nano-sized particles are doped with said electron trapping material.

14. The composite of claim 8, wherein said coating layer of said second material is in a range of 30 nm to 60 nm.

15. The composite of claim 14, wherein said coating layer has a thickness of 50 nm.

16. The composite of claim 8, wherein said electron depletion zone has a thickness in a range of 50 nm to 100 nm.

17. The composite of claim 9, wherein a space between adjacent seed materials is in a range of 50-100 nm.

18. A composite electrolyte material comprising:
a composite electrolyte phase having high ionic conductivity and suppressed electronic conductivity and defining a continuous phase having an interconnected pore network; and
a strengthening material phase provided within said interconnected pore network.

19. A method of making the composite electrolyte material of claim 18 comprising the steps of:
providing a structure comprising said composite electrolyte phase;
bisque firing said structure to form said interconnected pore network in said composite electrolyte phase;
infiltrating said strengthening material into said interconnected pore network; and
sintering said structure after said infiltrating step to provide said composite electrolyte material.

20. The method of claim 19, wherein said sintering step comprises microwave sintering.

21. The composite of claim 18, wherein said strengthening material comprises an oxide stabilized zirconia that yields a finely sintered phase of tetragonal zirconia whereby the mechanical structure and properties of the final composite material are improved.

22. The composite of claim 21, wherein said strengthening material comprises a material selected from the group consisting of yttria, calcia and magnesia.
